(19) United States
(12) Patent Application Publication
(10) Pub. No.: US 2020/0041749 A1
(43) Pub. Date: Feb. 6, 2020

(54) LENS AND LENS MODULE INCLUDING THE SAME

(71) Applicant: AAC Technologies Pte. Ltd., Singapore city (SG)

(72) Inventor: Hailong Wang, Shenzhen (CN)

(21) Appl. No.: 16/528,663

(22) Filed: Aug. 1, 2019

(30) Foreign Application Priority Data
Aug. 6, 2018 (CN) 201821263109.4

(51) Int. Cl. G02B 7/02

(52) U.S. Cl. CPC G02B 7/021

(57) ABSTRACT

The present disclosure relate to the field of optical imaging technologies, and discloses a lens and a lens module including the same. The lens includes: an optical portion located at a central position; a bearing portion surrounding the optical portion; and a reinforcing portion embedded in the bearing portion and configured to reinforce the bearing portion. The reinforcing portion is annular. The bearing portion includes an object-side surface close to an object side and an image-side surface opposite to the object-side surface. The reinforcing portion is located between the object-side surface and the image-side surface in a direction parallel with an optical axis. The lens and the lens module including the lens provided by the present disclosure can enhance the ability to resist deformation of the lens, thereby improving the yield of the lens module.

### TECHNICAL FIELD

The present disclosure relate to the field of optical imaging technologies, and in particular, to a lens and a lens module including the same.

### BACKGROUND

With the continuous development of technology, electronic devices become more and more intelligent. In addition to digital cameras, portable electronic devices such as tablet PC and mobile phones are also equipped with lens modules having a photographing function in order to meet the users' requirements to take photos at any time. In the related art, a lens module includes a plurality of lenses pressed against each other.

The inventors have found that at least the following problems exist in the related art. The lens in the lens module may be deformed by extrusion of the adjacent optical assembly, so that stability is not high when assembling the lens module, thereby reducing the yield of the lens module.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a perspective schematic structural view of a lens according to a first embodiment of the present disclosure;

FIG. 2 is a cross-sectional schematic structural view of the lens according to a first embodiment of the present disclosure; and

FIG. 3 is a cross-sectional schematic structural view of a lens module according to a second embodiment of the present disclosure.

### DESCRIPTION OF EMBODIMENTS

The present disclosure will be further illustrated with reference to the accompanying drawings and the embodiments.

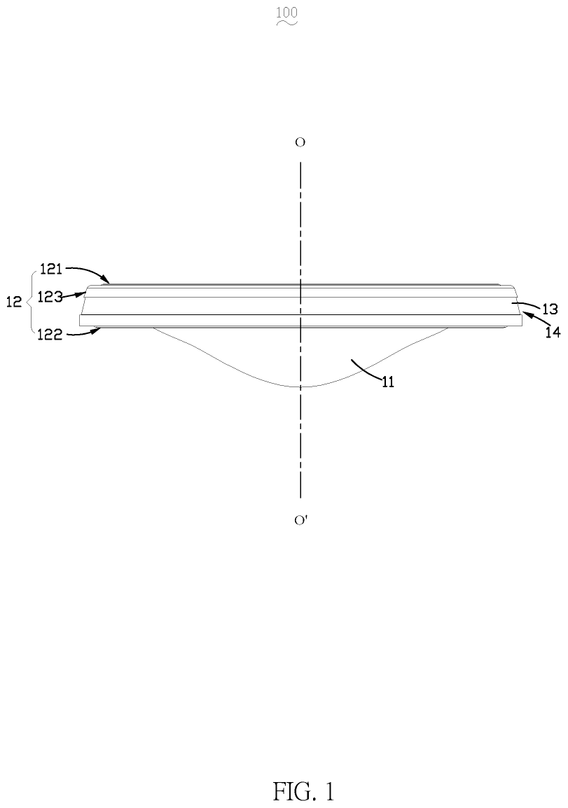

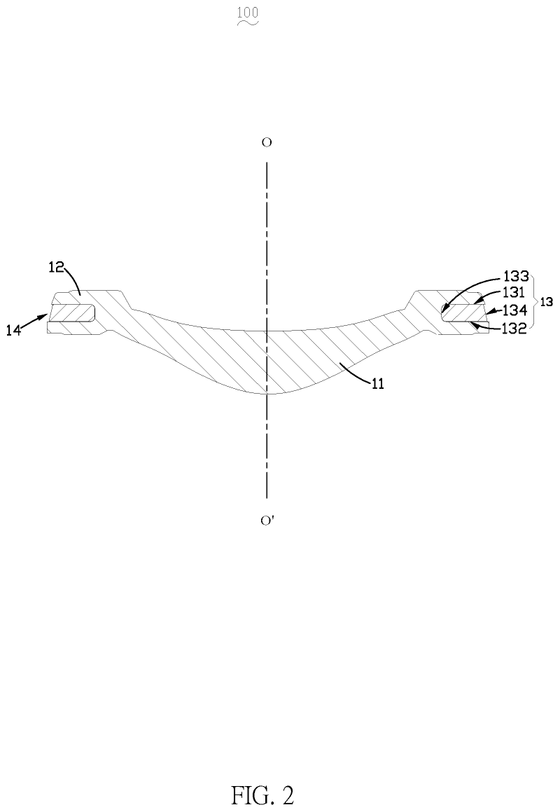

A first embodiment of the present disclosure provides a lens 100. As shown in FIGS. 1 to 2, the lens 100 includes an optical portion 11, a bearing portion 12, and a reinforcing portion 13. The optical portion 11 is located at a central position. The bearing portion 12 surrounds the optical portion 11. The reinforcing portion 13 is embedded in the bearing portion 12 and configured to reinforce the rigidity of the bearing portion 12. The reinforcing portion 13 is annular. The bearing portion 12 includes an object-side surface 121 adjacent to the object side and an image-side surface 122 opposite to the object-side surface 121. The reinforcing portion 13 is located between the object-side surface 121 and the image-side surface 122 in a direction parallel with an optical axis OO′.

Compared with the related art, in this embodiment, the reinforcing portion 13 is embedded in the bearing portion 12 and configured to reinforce the rigidity of the bearing portion 12, so that the ability to resist deformation of the lens 100 is enhanced, thereby improving the stability in assembly of the lens module, improving the yield of the product, and saving the production cost. Meanwhile, since the reinforcing portion 13 is annular, the annular reinforcing portion 13 can increase the rigidity of the bearing portion 12 from various directions, thereby further improving the ability to resist deformation of the lens 100. In addition, the annular reinforcing portion 13 is more easily fixed in the recessed portion 14, thereby improving the convenience of processing.

In this embodiment, the optical portion 11 and the bearing portion 12 are made of a plastic material; the reinforcing portion 13 is made of a metal material; and the bearing portion 12 and the reinforcing portion 13 are formed into one piece. During the forming of a plastic lens 100, an annular metal block and a plastic part are directly fused together, so that the metal block can be fixed in the plastic lens 100. In this way, the ability to resist deformation may become stronger since the bearing portion 12 of the resulting lens 100 has the metal block, thereby improving the mechanical imbalance of the lens 100. Since the lens 100 has been directly fixed to the reinforcing portion 13 during the forming process, there is no need to additionally fix the reinforcing portion 13, which simplifies the manufacturing process and saves production cost. Moreover, this makes the fixation between the bearing portion 12 and the reinforcing portion 13 tighter, thereby improving the ability to resist deformation of the lens 100. In addition, since the metal material has a high rigidity, is abundant resources and is easy to process, the metal reinforcing portion 13 can greatly improve the rigidity of the bearing portion 12, and meanwhile, the material is convenient to obtain and process. Since the plastic material having a high light transmittance and a low melting point and is easy to be shaped, the plastic optical portion 11 and the plastic bearing portion 12 can ensure the optical performance of the lens 100 and are easy to process.

Further, the bearing portion 12 further includes a peripheral surface 123 which connects the object-side surface 121 with the image-side surface 122. The bearing portion 12 is provided with a recessed portion 14 recessed from the peripheral surface 123 towards the optical axis OO′. The reinforcing portion 13 is fixed in the recessed portion 14. Since the recessed portion 14 extends from the peripheral surface 123 towards the optical axis OO′ and the reinforcing portion 13 is provided in the recessed portion 14, the reinforcing portion 13 is exposed out of the peripheral surface 123 of the bearing portion 12. Therefore, the reinforcing portion 13 can be fixed more conveniently during forming of the plastic portion of the lens 100, thereby increasing the convenience of the manufacturing process.

Optionally, the reinforcing portion 13 includes a first surface 131, a second surface 132, an inner side surface 133 and an outer side surface 134. The first surface 131 and the second surface 132 are opposite to each other in a direction of the optical axis OO′. The inner side surface 133 and the outer side surface 134 connect the first surface 131 and the second surface 132. The outer side surface 134 is recessed from the peripheral surface 123 towards the optical axis OO′.

In this embodiment, the reinforcing portion 13 has equal distances to the object-side surface 121 and the image-side surface 122 in a direction parallel with the optical axis OO′. In this way, the bearing portion 12 has a thick abutting portion on upper and lower sides of the reinforcing portion 13. Therefore, it can ensure that the reinforcing portion 13 can be firmly fixed in the bearing portion 12, thereby improving the reliability of the lens 100.

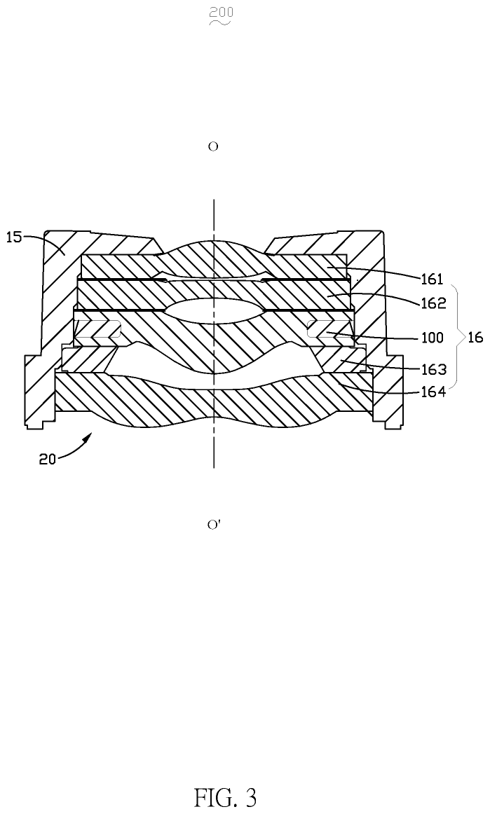

A second embodiment of the present disclosure provides a lens module 200. As shown in FIG. 3, the lens module 200 includes a lens barrel 15 having a receiving space 20, and an optical assembly 16 received in the receiving space 20. The optical assembly 16 includes a first lens 161 close to the object side, a second lens 162 provided at the image side of the first lens 161, a light-blocking plate 163 provided at the image side of the second lens 162, a fourth lens 164 provided at the image side of the light-blocking plate 163, and the lens 100 provided between the second lens 162 and the light-blocking plate 163.

The lens 100 is easily twisted under two pressing forces, and the lens 100, in particular, the plastic lens can be deformed. The plastic lens is easily deformed due to the small rigidity and deformation of the plastic. The lens deformation may cause the lens module to be very instable when the lens module is assembled in practice, thereby affecting the performance of the lens module and reducing the yield of the product. In this embodiment, by embedding the reinforcing portion in the bearing portion for enhancing the rigidity of the bearing portion, the rigidity of the lens 100 is further improved, and the deformation of the lens 100 is reduced, thereby improving the stability of the lens module 200 during the assembling and improving the yield of the product.

The above are only preferred embodiments of the present disclosure. Here, it should be noted that those skilled in the art can make modifications without departing from the inventive concept of the present disclosure, but these shall fall into the protection scope of the present disclosure.

What is claimed is:

1. A lens, comprising:
an optical portion located at a central position;
a bearing portion surrounding the optical portion; and
a reinforcing portion embedded in the bearing portion and configured to reinforce the bearing portion,
wherein the reinforcing portion is annular; the bearing portion comprises an object-side surface close to an object side and an image-side surface opposite to the object-side surface;
and the reinforcing portion is located between the object-side surface and the image-side surface in a direction parallel with an optical axis.

2. The lens as described in claim 1, wherein the bearing portion further comprises a peripheral surface connecting the object-side surface with the image-side surface, a recessed portion recessed from the peripheral surface towards the optical axis is provided on the bearing portion; and the reinforcing portion is fixed in the recessed portion.

3. The lens as described in claim 2, wherein the reinforcing portion comprises a first surface, a second surface, an inner side surface and an outer side surface; the first surface and the second surface are opposite to each other in a direction of the optical axis; the inner side surface and the outer side surface connect the first surface with the second surface; and the outer side surface is recessed from the peripheral surface towards the optical axis.

4. The lens as described in claim 3, wherein the reinforcing portion has equal distances to the object-side surface and the image-side surface in a direction parallel with the optical axis.

5. The lens as described in claim 1, wherein the reinforcing portion is made of a metal material.

6. The lens as described in claim 5, wherein the bearing portion and the reinforcing portion are formed into one piece.

7. A lens module, comprising the lens as described in claim 1.

8. A lens module, comprising the lens as described in claim 2.

9. The lens module as described in claim 7, further comprising:
a lens barrel having a receiving space; and
an optical assembly received in the receiving space,
wherein the optical assembly comprises a first lens close to the object side, a second lens provided at an image side of the first lens, a light-blocking plate provided at an image side of the second lens, a fourth lens provided at an image side of the light-blocking plate, and the lens provided between the second lens and the light-blocking plate.
